(19) United States
(12) Patent Application Publication
(10) Pub. No.: US 2009/0007006 A1
(43) Pub. Date: Jan. 1, 2009

(54) AUTOMATIC SCROLLING

(75) Inventors: Tong Liu, San Diego, CA (US); Wen Zhao, Cupertino, CA (US); Janell L. Paulson, Carlsbad, CA (US); Isabel Mahe, Los Altos, CA (US)

Correspondence Address: KACVINSKY LLC;C/O INTELLEVATE, P.O. BOX 52050, MINNEAPOLIS, MN, 55402, US

(73) Assignee: PALM, INC., Sunnyvale, CA (US)

(21) Appl. No.: 11/771,460

(22) Filed: Jun. 29, 2007

(51) Int. Cl. G06F 3/048

(52) U.S. Cl. 715/784

(57) ABSTRACT

Techniques for scrolling through displayed information are disclosed. For instance, an apparatus includes a scrolling management module to set one or more automatic scrolling preferences, and an application to output a content item in accordance with the one or more automatic scrolling preferences. Examples of such scrolling preferences include scrolling speeds, designated input mechanism(s) to adjust scrolling, and the activation/deactivation of orientation-based scrolling.

### BACKGROUND

Mobile computing devices, such as smart phones, may provide various processing capabilities. For example, mobile devices may provide personal digital assistant (PDA) features, including word processing, spreadsheets, synchronization of information (e.g., e-mail) with a desktop computer, and so forth.

In addition, such devices may have wireless communications capabilities. More particularly, mobile devices may employ various communications technologies to provide features, such as mobile telephony, mobile e-mail access, web browsing, and content (e.g., video and radio) reception. Exemplary wireless communications technologies include cellular, satellite, and mobile data networking technologies.

Such devices are often adapted for handheld operation. However, due to their compact size, various user interactions, such as scrolling, may be difficult at times. Scrolling may be employed to change which portions of a content item are being output on a display or screen. Examples of content items include word processing documents, e-mails, web pages, lists, menu selections, contents of a folder, and so forth.

Unfortunately, for handheld devices, scrolling is typically a two-handed operation. More particularly, scrolling typically requires one hand to hold the device and another hand to push buttons or operate a touch screen with a stylus. Also, while some handheld devices provide mechanisms (e.g., up/down buttons, track balls, and/or side wheels) to provide single-handed scrolling, such mechanisms are often inconvenient.

Thus, scrolling operations may be inconvenient, awkward, or impractical in certain situations, such as in moving or unstable environments like crowded buses or trains.

### BRIEF DESCRIPTION OF THE DRAWINGS

FIG. 1A illustrates an embodiment of an apparatus.

FIG. 1B illustrates a further embodiment of an apparatus.

FIG. 2 illustrates an exemplary implementation embodiment.

FIG. 3 is an exemplary flow diagram.

FIGS. 4A and 4B are views of an exemplary handheld device.

FIGS. 5A-5D are diagrams showing orientation-based scrolling examples.

FIG. 6 illustrates an embodiment of a system.

### DETAILED DESCRIPTION

Embodiments may be generally directed to techniques for scrolling through displayed information. For instance, an apparatus may include a scrolling management module to set one or more automatic scrolling preferences, and an application to output a content item in accordance with the one or more automatic scrolling preferences. Exemplary content items include word processing documents, e-mails, web pages, lists (e.g., photo thumbnails), menu selections, contents of a folder, and so forth.

Examples of such scrolling preferences include scrolling speeds, designated input mechanism(s) to adjust scrolling, and the activation/deactivation of orientation-based scrolling. The embodiments, however, are not limited to these examples. Various advantages may be obtained through the techniques disclosed herein. For example, viewing information may become more convenient and less difficult.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include other combinations of elements in alternate arrangements as desired for a given implementation. It is worthy to note that any reference to “one embodiment” or “an embodiment” means that a particular feature, structure, or characteristic described in connection with the embodiment is included in at least one embodiment. The appearances of the phrase “in an embodiment” in various places in the specification are not necessarily all referring to the same embodiment.

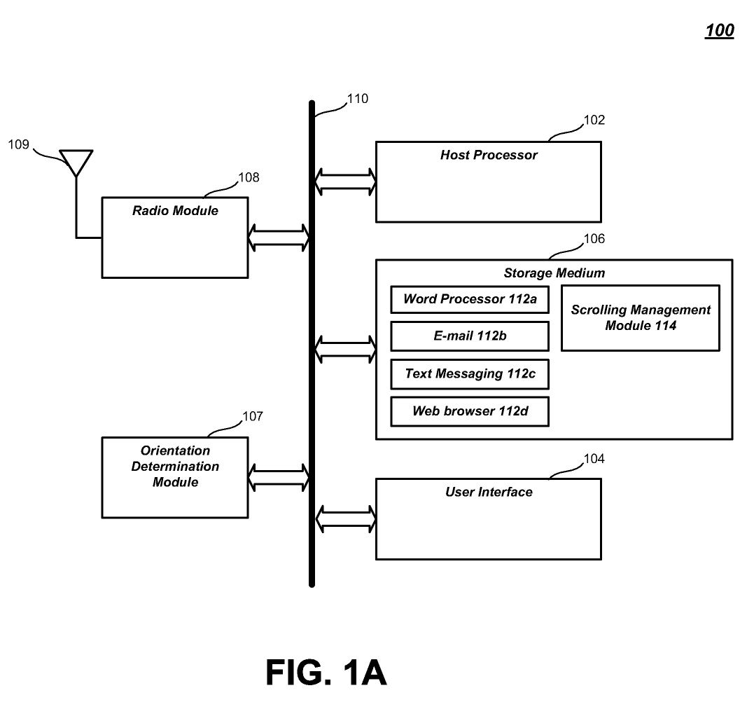

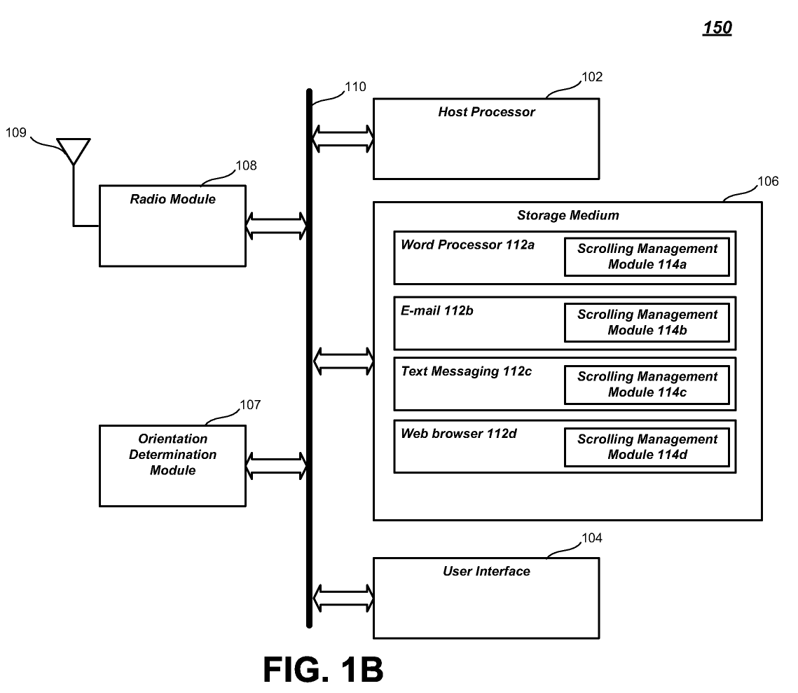

FIG. 1A illustrates one embodiment of an apparatus that may provide automatic scrolling features. In particular, FIG. 1A shows an apparatus 100 comprising various elements. The embodiments, however, are not limited to these depicted elements. FIG. 1A shows that apparatus 100 may include a host processor 102, a user interface 104, a storage medium 106, an orientation determination module 107, a radio module 108, and an interconnection medium 110. These elements may be implemented in hardware, software, firmware, or in any combination thereof. Such software implementations may involve control logic or instructions stored, for example, by storage medium 106.

Host processor 102 may perform various operations. For instance, host processor 102 may execute applications, such as text messaging, e-mail, web browsing, word processing, file browsers, utilities and so forth. Such applications may be operated or employed by a user through user interface 104.

Also, host processor 102 may perform operations in accordance with various communications protocols to provide for the exchange of information with remote devices. Moreover, host processor 102 may provide one or more functional utilities. Such utilities may be available to application(s), communications protocol(s), etc. Exemplary utilities include operating systems, graphical user interfaces, device drivers, and so forth. Examples of operating systems include various versions of Palm OS by Palm, Inc. of Sunnyvale, Calif., and various versions of Windows Mobile by Microsoft Corporation of Redmond, Wash. The embodiments, however, are not limited to these examples.

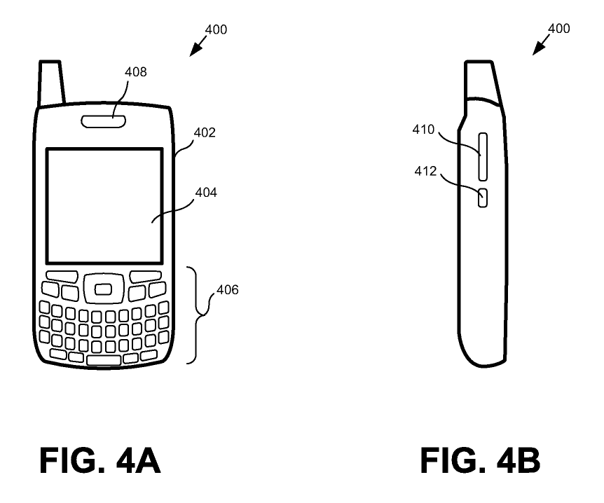

User interface 104 facilitates user interaction with apparatus 100. This interaction may involve the input of information from a user and/or the output of information to a user. Accordingly, user interface 104 may include one or more devices, such as a keyboard (e.g., a full QWERTY keyboard), a keypad, a touch screen, a microphone, and/or an audio speaker. The embodiments are not limited to these examples. An exemplary user interface is described below with reference to FIG. 4.

Storage medium 106 may store information in the form of data. For instance, memory 106 may contain application documents, e-mails, sound files, and/or images in either encoded or unencoded formats. Also, storage medium 106 may store information contained and managed by configuration database 204.

Moreover, as described above, storage medium 106 may store control logic or instructions (e.g., software) that may be executed by processors, such as host processor 106. Moreover, such control logic or instructions may provide functionality for one or more elements, such as user interface 104 and/or radio module 108. The embodiments, however, are not limited to these examples.

For example, FIG. 1A shows storage medium 106 including multiple applications 112, and a scrolling management module 114. Applications 112 may each provide a user with the ability to view content through a display, such as a touch screen. For instance, FIG. 1A shows a word processing application 112a, an e-mail application 112b, a text messaging application 112c, and a web browser application 112d. The embodiments, however, are not limited to these exemplary applications.

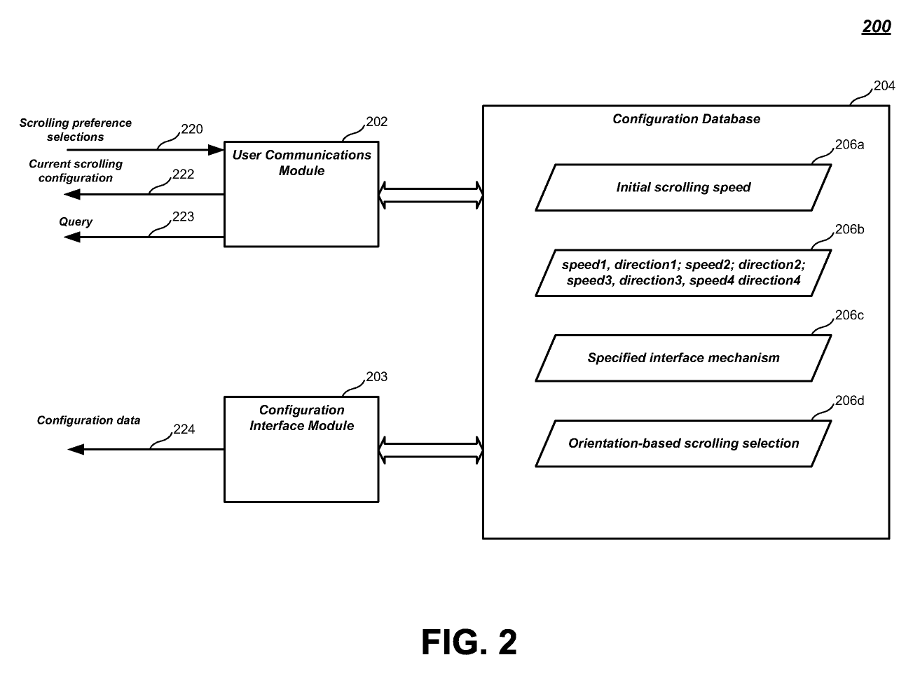

Scrolling management module 114 facilitates automatic scrolling features. In embodiments, scrolling management module 114 may be implemented within a graphical user interface utility or operating system (not shown). An exemplary implementation of scrolling management module 114 is described below with reference to FIG. 2.

Storage medium 106 may be implemented using any machine-readable or computer-readable media capable of storing data, including both volatile and non-volatile memory. Examples of such media are provided below.

Orientation determination module 107 determines the orientation of apparatus 100. For instance, orientation determination module 107 may determine azimuth and/or elevation (or “tilting”) orientations of apparatus 100. Accordingly, in embodiments, scrolling may be adjusted or set based on the orientation of apparatus 100. For example, scrolling speed and/or direction may be based on the degree and direction to which apparatus 100 is tilted. However, in further embodiments, orientation determination module 107 may be implemented in other ways. For instance, orientation determination module 107 may comprise a global positioning system (GPS). In such embodiments, orientations may be based on positions (or changes in position) of apparatus 100.

Orientation determination module 107 may be implemented in various ways. For instance, this module may be implemented with solid state compass. Such a compass may comprise multiple magnetic field sensors that provide data upon which calculations may be performed. Such calculations may be performed by orientation determination module 107 or other elements, such as host processor 102.

Radio module 108 (through an antenna 109) may provide communications with remote devices across different types of wireless links. For example, radio module 108 may communicate across data networking links. Alternatively or additionally, radio module 108 may communicate across wireless links provided by one or more cellular systems. Examples of wireless links are provided below.

Interconnection medium 110 provides for couplings among elements, such as host processor 102, user interface 104, storage medium 106, orientation determination module 107, and radio module 108. Thus, interconnection medium 110 may include, for example, one or more bus interfaces. Exemplary interfaces include Universal Serial Bus (USB) interfaces, as well as various computer system bus interfaces. Additionally or alternatively, interconnection medium 110 may include one or more point-to-point connections (e.g., parallel interfaces, serial interfaces, etc.) between various element pairings. Such connections may comprise one or more signal lines. Moreover, interconnection medium 110 may include non-physical aspects. For instance, such interconnectivity may be implemented through messages passed between processes or software modules.

In embodiments, interconnection medium 110 may provide for the exchange of information between user interface 104, scrolling management module 114, and various applications 112 and/or utilities, as described herein.

FIG. 1A shows scrolling management module 114 being implemented alongside (e.g., separate from) various applications. However, the embodiments are not limited to such implementations. For instance, as described above, scrolling management module 114 may be included in a GUI utility or operating system.

Furthermore, one or more applications may include scrolling management modules 114. For example, FIG. 1B shows instantiations of scrolling management module 114 “embedded” in multiple applications. More particularly, FIG. 1B shows a scrolling management module 114a within word processing application 112a, a scrolling management module 114b within e-mail application 112b, a scrolling management module 114c within text messaging application 112c, and a scrolling management module 114d within web browser application 112d.

Through such arrangements, each application may have specific scrolling configurations. Such application-specific scrolling preferences are referred to herein as local scrolling preferences. However, in embodiments, global scrolling preferences (which apply to multiple applications) may be employed. In such cases, a single scrolling management module 114 (as in FIG. 1A) may be used. The embodiments, however, are not limited to such implementations.

FIG. 2 is a diagram of an implementation 200 that may be employed in scrolling management module 114. Implementation 200 may include various elements. For instance, FIG. 2 shows implementation 200 including a user communications module 202, a configuration interface module 203, and a configuration database 204. These elements may be implemented in hardware, software, firmware, or any combination thereof.

As shown in FIG. 2, configuration database 204 includes multiple data items 206. Data items 206 specify various automatic scrolling settings. For instance, a data item 206a specifies an initial scrolling speed to be employed when a content item is opened. Thus, when an application, such as a browser, opens a content item (e.g., a web page), this initial scrolling speed may be automatically employed.

A data item 206b establishes a sequence of scrolling speeds and directions that may be selected through user interaction with a particular interface mechanism that is specified by data item 206c. Scrolling directions include forward (scrolling down) and reverse (or scrolling up). However, other directions, such as sideways (e.g., sideways left and sideways right) may also be specified.

With reference to FIGS. 1A and 1B, the interface mechanism specified by data item 206c may be within user interface 104. An exemplary interface mechanism is a push button on a handheld device, such as a smartphone. The embodiments, however, are not limited to such mechanisms or devices.

A push button mechanism may allow a user to cycle through a sequence of scrolling speeds and/or directions. These speeds and/or directions may be specified by data item 206b. For example, FIG. 2 shows data item 206b specifying a sequence of four speeds and directions (i.e., speed1, direction1; speed2, direction2; speed3, direction3; and speed4, direction4). The embodiments, however, are not limited to four speeds and/or directions.

As described above, such sequences may be traversed through an interface mechanism, such as the one specified by data item 206c. For instance, a single button push may change the employed scrolling speed from a first speed to a second speed specified by data item 206c. Additionally two button pushes in quick succession may change the scrolling in an opposite direction in the sequence specified by data 206c. For example, two such button pushes may change the employed scrolling speed from the second speed to the first speed. The sequence specified by data item may be traversed in a circular manner. Thus, successive button pushes may continually cause changes in the employed scrolling speed.

FIG. 2 also shows configuration database 204 having a data item 206d. This data item is used to selectively activate or deactivate orientation-based scrolling. As described above, orientation-based scrolling involves scrolling being set or adjusted based on a device's orientation. For example, scrolling speed and/or direction for a content item may be based on the degree and direction to which a device is tilted.

As shown in FIG. 2, user communications module 202 provides for the exchange of information with users. For instance, user communications module 202 may receive scrolling preference selections 220 from a user interface (such as user interface 104). Based on these selections, data items 206 may be set. Moreover, interface module 202 may send information to a user interface. For instance, FIG. 2 shows user communications module 202 providing a current scrolling configuration 222 (e.g., values of data items 206) to a user interface. In addition, user communications module 202 may send a query 223 for data item settings to a user interface.

Configuration interface module 203 provides for the exchange of information with various applications. For example, FIG. 2 shows configuration interface module 203 providing configuration data 224, which may include one or more of data items 206. Configuration data 224 may be sent to applications to provide scrolling features, such as the ones described herein. Alternatively or additionally, configuration data 224 may be sent to utilities, such as graphical user interface modules, operating systems, and so forth. Such utilities may operate to provide scrolling features. This data may be retrieved from or “pushed” to such applications and/or utilities.

As described above, instantiations of scrolling management module 114 may be implemented (or embedded) within applications. Thus, implementation 200 may be included within a corresponding application. Accordingly, configuration data 224 may be sent to the corresponding application or utility. Additionally or alternatively, other information (e.g., scrolling preference selections 220, current scrolling configuration 222, and/or query 223) may be exchanged with the user interface via the corresponding application or utility.

Operations for embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented, unless otherwise indicated. In addition, the given logic flow may be implemented by a hardware element, a software element executed by a processor, or any combination thereof. The embodiments are not limited in this context.

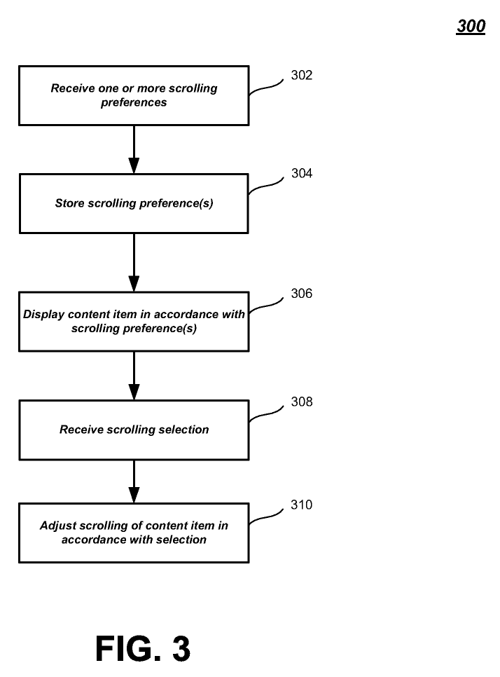

FIG. 3 illustrates one embodiment of a logic flow. In particular, FIG. 3 illustrates a logic flow 300, which may be representative of the operations executed by one or more embodiments described herein. As shown in FIG. 3, logic flow 300 includes a block 302, at which one or more scrolling preferences are received from a user. With reference to FIG. 2, these preferences may include values for data items 206.

At a block 304, the one or more scrolling preferences are stored. In the contexts of FIGS. 1A and 1B, these preferences may be stored in storage medium 106. Further, with reference to FIG. 2, these preferences may be stored as data items 206 by a scrolling management module. However, the embodiments are not limited to these examples.

Blocks 302 and 304 may be performed by an entity such as scrolling management module 114. As described above, instantiations of scrolling management module 114 may be implemented (or embedded) within applications. Thus, blocks 302 and 304 may be performed by a scrolling management module within a particular application. For instance, the reception of scrolling preferences in block 302 may occur after the particular application has been opened (e.g., once its execution has commenced).

Also, the scrolling preferences stored in block 304 may be constrained to the particular application (local scrolling preferences). Alternatively, such preferences may be applied globally or to multiple applications or utilities (global scrolling preferences).

At a block 306, a content item is displayed in accordance with the one or more scrolling preferences. For instance, an application or utility displaying the content item may employ corresponding local scrolling preferences that were established through its embedded scrolling management module. Alternatively, the application or utility displaying the content item may employ global scrolling preferences. As described above, examples of content items include word processing documents, e-mails, web pages, lists (e.g., photo thumbnails), menu selections, contents of a folder, and so forth.

FIG. 3 shows that, at a block 308, a scrolling selection is received from the user. This scrolling selection may be from among one or more scrolling speeds and/or directions that are stored as preferences in block 304. Thus, at a block 310, the scrolling of the content item is adjusted according to this selection.

The user scrolling selection(s) received at block 308 may be in various forms. For instance, the selection(s) may be one or more actions (e.g., button depressions) on a designated input mechanism. As a example, a designated device button may be depressed one or more times to traverse a cycle of specified scrolling speeds and/or directions. As described above with reference to FIG. 2, such speeds and/or directions may be specified by data item 206b.

Additionally or alternatively, the selection(s) may be the establishment of a device orientation. For instance, the device may be tilted to adjust the scrolling speed and/or direction applied to the displayed content item. In the contexts of FIGS. 1A and 1B, device orientation may be determined by orientation determination module 107. Also, with reference to FIG. 2, activation of orientation-based scrolling may be based on data item 206d.

FIGS. 4A and 4B provide views of an exemplary handheld device 400. In particular, FIG. 4A is a front view that shows device 400 having a case 402. Further, this view shows device 400 having a display (e.g., a touch screen) 404, a keypad 406 (including, for example, a QWERTY keyboard, navigation buttons, and so forth), and a speaker 408. With reference to FIGS. 1A and 1B, these components may be included in user interface 104.

FIG. 4B is a side view of apparatus 400. In particular, this view is from the left side of FIG. 4A. As shown in FIG. 4B, apparatus 400 further includes buttons 410 and 412. In the contexts of FIGS. 1A and 1B, these buttons may also be included in user interface 104. Further, one of these buttons may be a specified interface mechanism for scrolling operations. However, other mechanisms may be specified. In the contexts of FIG. 2, such a mechanism is specified by data item 206c.

The views of FIGS. 4A and 4B are provided for the purposes of illustration, and not limitation. Thus, embodiments may include further devices, handheld or otherwise.

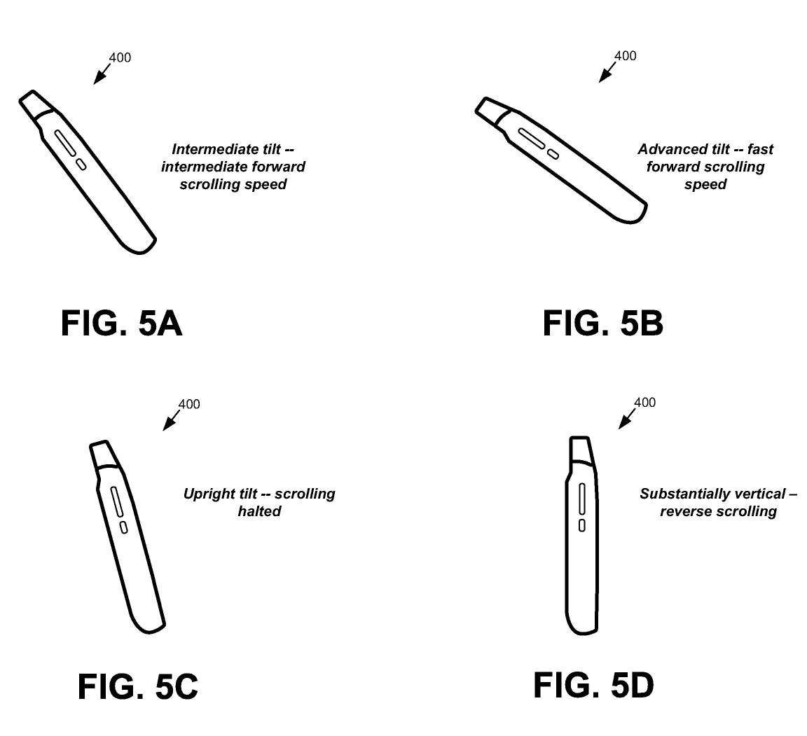

As described above, embodiments may employ orientation-based scrolling. Such scrolling may be based, for example, on the tilting orientation of a device. FIGS. 5A-5D are diagrams showing examples of scrolling based on the tilting of device 400. In particular, FIG. 5A shows an intermediate tilt in which an intermediate forward scrolling speed occurs. However, FIG. 5B shows an advanced tilt in which a fast forward scrolling speed occurs. An upright tilt is shown in FIG. 5C. This upright tilt halts scrolling. In contrast, FIG. 5D shows a substantially vertical orientation in which a reverse scrolling occurs.

The views of FIGS. 5A-5D show particular scrolling settings corresponding to certain amounts of “tilt”. However, embodiments may associate any number of scrolling operations or setting to any number of tilts. Also, scrolling directions other than forward and reverse (e.g., sideways left and sideways right) may be controlled by tilting. Moreover, embodiments may associate scrolling operations or settings to orientations other than tilt.

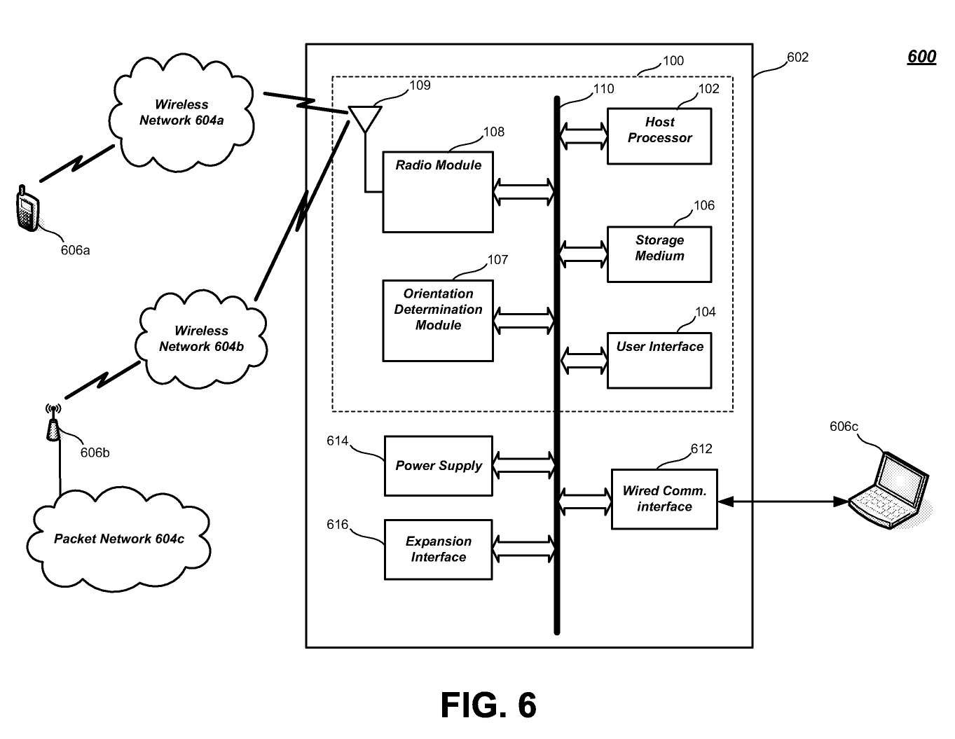

FIG. 6 illustrates an embodiment of a system 600. This system may be suitable for use with one or more embodiments described herein, such as apparatus 100, implementation 200, logic flow 300, and so forth. Accordingly, system 600 may engage in wireless communications across various link types, such as the ones described herein. In addition, system 600 may perform various applications.

As shown in FIG. 6, system 600 may include a device 602, multiple communications networks 604, and one or more remote devices 606. FIG. 6 shows that device 602 may include the elements of FIG. 1A. However, device 602 may include the elements of other embodiments (such as the embodiment of FIG. 1B).

Also, device 602 may include a wired communications interface 612, a power supply (e.g., a battery) 614, and an expansion interface 616. These elements may be implemented in hardware, software, firmware, or any combination thereof.

Power supply 614 provides operational power to elements of device 602. Accordingly, power supply 614 may include a battery. Such a battery may be rechargeable and/or removable. Alternatively or additionally, power supply 614 may include an interface to an external power source, such as an alternating current (AC) source. However, the embodiments are not limited to these examples.

Wired communications interface 612 provides for the exchange of information with a device 606c (e.g., a proximate device), such as a personal computer. This exchange of information may be across one or more wired connections. Examples of such connections include USB interfaces, parallel interfaces, and/or serial interfaces. In addition, interface 612 may provide for such exchanges across wireless connections(s). An infrared interface is an example of such a connection. The information exchanged with such proximate devices, may include e-mail, calendar entries, contact information, as well as other information associated with personal information management applications. In addition, such information may include various application files, and content (e.g., audio, image, and/or video).

Wired communications interface 612 may include various components, such as a transceiver and control logic to perform operations according to one or more communications protocols. In addition, communications interface 612 may include input/output (I/O) adapters, as well as physical connectors to connect the I/O adapter with a corresponding communications medium.

FIG. 6 shows that device 602 may communicate across wireless networks 604a and 604b. In particular, FIG. 6 shows these communications being handled by radio module 108. First wireless network 604a may be a cellular network, while second wireless network 604b may be a wireless data network. The embodiments, however, are not limited to these examples.

Such wireless communications allow device 602 to communicate with various remote devices. For instance, FIG. 6 shows device 602 engaging in wireless communications (e.g., telephony or messaging) with a mobile device 606a. In addition, FIG. 6 shows device engaging in wireless communications (e.g., WLAN, WMAN, and/or PAN communications) with an access point 606b. In turn access point 606b may provide device 602 with access to further communications resources. For example, FIG. 6 shows access point 606b providing access to a packet network 604c, such as the Internet.

Expansion interface 616 may be in the form of an expansion slot, such as a secure digital (SD) slot. Accordingly, expansion interface 616 may accept memory, external radios (e.g., global positioning system (GPS), Bluetooth, WiFi radios, etc.), content, hard drives, and so forth. The embodiments, however, are not limited to SD slots. Other expansion interface or slot technology may include memory stick, compact flash (CF), as well as others.

As described above, embodiments may communicate across various types of wireless links, such as data networking links and/or links provided by cellular systems.

Examples of data networking links include wireless local area network (WLAN) links, such as IEEE 802.11 WiFi links. Further examples include wireless metropolitan area (WMAN) links, such as IEEE 802.16 WIMAX links, and personal area networks (PAN) links such as Bluetooth links. The embodiments, however, are not limited to these examples.

Exemplary cellular systems include Code Division Multiple Access (CDMA) systems, Global System for Mobile Communications (GSM) systems, North American Digital Cellular (NADC) systems, Time Division Multiple Access (TDMA) systems, Extended-TDMA (E-TDMA) systems, Digital Advanced Mobile Phone Service (IS-136/TDMA), Narrowband Advanced Mobile Phone Service (NAMPS) systems, third generation (3G) systems such as Wide-band CDMA (WCDMA), CDMA-2000, Universal Mobile Telephone System (UMTS), cellular radiotelephone systems compliant with the Third-Generation Partnership Project (3GPP), and so forth. However, the embodiments are not limited to these examples. For instance, radio module 108 may additionally or alternatively communicate across non-cellular communications links.

Further, embodiments may include storage media, such as storage medium 106. Such storage media may be implemented in various ways. For example, such storage media may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of storage medium 106 may be included in other elements of apparatus 100. For instance, some or all of storage medium 106 may be included on a same integrated circuit or chip with elements of apparatus 100 (e.g., host processor 106). Alternatively, some portion or all of storage medium 106 may be disposed on an integrated circuit or other medium (e.g., a hard disk drive) that is external. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Operations for embodiments have been described with reference to various figures and examples. Some of the figures may include a logic flow or operational sequence. Although such figures presented herein may include a particular logic flow or operational sequence, it can be appreciated that these merely provide an example of how general functionality as described herein can be implemented. Further, given logic flows and operational sequences does not necessarily have to be executed in the order presented, unless otherwise indicated. In addition, the given logic flow may be implemented by a hardware element, a software element executed by a processor, or any combination thereof. The embodiments are not limited in this context.

Moreover, the scrolling features described herein are not limited to word processing applications, e-mail applications text messaging applications, web browser applications. For instance, other applications may employ such features. Examples of such other applications include spreadsheets, file browsers, presentation applications, and applications providing content in lists, menus or other scrollable forms. The embodiments, however, are not limited to these further examples.

Further, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a scrolling management module to set one or more automatic scrolling preferences;
an application to output a content item in accordance with the one or more automatic scrolling preferences.

2. The apparatus of claim 1, wherein the one or more scrolling preferences includes automatic scrolling through the content item upon an opening of the content item.

3. The apparatus of claim 1, wherein the one or more scrolling preferences includes one or more user-selectable scrolling speeds.

4. The apparatus of claim 3, further comprising a user input device for a user to select among the one or more scrolling speeds while the content item is being output by the application.

5. The apparatus of claim 4, wherein the user input device includes a button, the button to provide for sequential selection among the one or more scrolling speeds.

6. The apparatus of claim 3, wherein the one or more user-selectable scrolling speeds includes a stop speed.

7. The apparatus of claim 3, wherein the one or more user-selectable scrolling speeds includes a reverse speed.

8. The apparatus of claim 1, wherein the apparatus is included in a handheld device, and wherein the one or more scrolling preferences includes scrolling based on an orientation of the handheld device.

9. The apparatus of claim 8, further comprising an orientation determination module to determine the orientation of the handheld device.

10. The apparatus of claim 9, wherein the orientation determination module comprises a compass.

11. The apparatus of claim 1, wherein the content item includes a word processing document, an e-mail, a browser document, a spreadsheet, a list, menu selections, folder contents, and/or a text file

12. The apparatus of claim 1, further comprising a display, wherein the application outputs the content item in accordance with the one or more scrolling preferences to the display.

13. A method, comprising:
storing one or more automatic scrolling preferences; and
displaying a content item in accordance with the one or more automatic scrolling preferences.

14. The method of claim 13, further comprising:
receiving the one or more automatic scrolling preferences from a user.

15. The method of claim 13, wherein the one or more automatic scrolling preferences includes one or more user-selectable scrolling speeds.

16. The method of claim 15, further comprising receiving a selection from among the one or more scrolling speeds while the content item is being output by the application.

17. An article comprising a machine-readable storage medium containing instructions that if executed enable a system to:
store one or more automatic scrolling preferences; and
display a content item in accordance with the one or more automatic scrolling preferences.

18. An apparatus, comprising:
an application to output a content item; and
a user input device for a user to select among the one or more scrolling speeds for the content item while the content item is being output by the application.

19. The apparatus of claim 18, further comprising a scrolling management module to set the one or more scrolling speeds.

20. The apparatus of claim 16, wherein the user input device includes a button, the button to provide for sequential selection among the one or more scrolling speeds.
